(19) United States
(12) Patent Application Publication
(10) Pub. No.: US 2004/0030591 A1
(43) Pub. Date: Feb. 12, 2004

(54) Computerized systems and methods of formatting and transferring data between disparate applications

(76) Inventor: Stewart Graham, Lake Bluff, IL (US)

Correspondence Address: Michael W. Goltry, PARSONS & GOLTRY, Suite 260, 340 East Palm Lane, Phoenix, AZ, 85004, US

(21) Appl. No.: 10/213,786

(22) Filed: Aug. 7, 2002

(51) Int. Cl. G06F 17/60

(52) U.S. Cl. 705/8

(57) ABSTRACT

A first one of a network of computers implements a first one of disparate applications. A second one of the network of computers implements a second one of the applications. The first one of the computers outputs first data in response to implementation of the first one of the applications. The second one of the computers outputs second data in response to implementation of the second one of the applications. The first one of the computers is incapable of processing the second data by implementing the first one of the applications. The second one of the computers is incapable of processing the first data by implementing the second one of the applications. The system incorporates a third set of instructions, which is embedded into the first one of the applications. The third set of instructions permits the first one of the computers to receive the second data from the first one of the computers and format the second data into formatted second data, and permits the first one of the computers to format the first data into formatted first data and submit the formatted first data to the second one of the computers. The formatted second data are capable of being processed by the first one of the computers in response to implementation of the first one of the applications. The formatted first data are capable of being process by the second one of the computers in response to implementation of the second one of the applications.

### FIELD OF THE INVENTION

This invention relates to computers and to computer implemented data transfer systems and methods.

### BACKGROUND OF THE INVENTION

Innovative business models often require equally innovative management and scheduling, which is especially the case with business models that utilize the Internet and other networked computer environments and that prosecute vast business infrastructures. From plant maintenance and inventory and supply controls to planning and scheduling, the difference between success and failure for many service, product supply and retail concerns often depends on the systems and method used to administer these internal operations.

In an effort to accommodate internal management and scheduling needs, skilled artisans have developed a variety of computer implemented systems and methods that greatly simplify these complicated and often daunting tasks. Unfortunately, disparate computerized management and scheduling methods, technologies and processes characterize the state of the art. As a result, and because management and scheduling operations often go hand and hand, businesses are constantly faced with the problem of transferring data between disparate management and scheduling technologies. In an effort to solve this persistent problem, skilled artisans have developed intermediate systems that permit data transfer between disparate management and scheduling systems and that permit the implementation of disparate technologies. However, current intermediate systems, commonly referred to as middleware, are expensive, difficult to learn how to use and difficult to install and implement, greatly increasing internal operating and training costs.

Given these and other deficiencies in the art, the need for certain new and useful improvements is evident.

### SUMMARY OF THE INVENTION

The above problems and others are at least partially solved and the above purposes and others realized in an improved system that includes a network of computers and disparate applications. A first one of the computer implements a first one of the applications. A second one of the computers implements a second one of the applications. The first one of the computers outputs first data in response to implementation of the first one of the applications. The second one of the computers outputs second data in response to implementation of the second one of the applications. The first one of the computers is incapable of processing the second data by implementing the first one of the applications. The second one of the computers is incapable of processing the first data by implementing the second one of the applications. The system incorporates a third set of instructions, which is embedded into the first one of the applications. The third set of instructions permits the first one of the computers to receive the second data from the first one of the computers and format the second data into formatted second data, and permits the first one of the computers to format the first data into formatted first data and submit the formatted first data to the second one of the computers. The formatted second data are capable of being processed by the first one of the computers in response to implementation of the first one of the applications. The formatted first data are capable of being process by the second one of the computers in response to implementation of the second one of the applications. In accordance with the invention, the first application is a plant management application and the second application is a planning and scheduling application.

Although the immediate embodiment is implemented in a multiuser computer environment, it can be implemented by a single computer, if desired. In this regard, the invention contemplates disparate first and second applications. A computer implements the first and second applications. First data are output by the computer in response to implementation of the first application by the computer, and second data are output by the computer in response to implementation of the second application by the computer. The computer is incapable of processing the second data by implementing the first application, and the computer is also incapable of processing the first data by implementing the second application. A third application embedded into the first application. The third application permits the computer to format the first data into formatted first data, and permits the computer to format the second data into formatted second data. The formatted second data are capable of being processed by the computer in response to implementation of the first application, and the formatted first data are capable of being processed by the computer in response to implementation of the second application. Preferably, the first application is a plant management application and the second application is a planning and scheduling application.

Consistent with the foregoing, the invention also contemplates associated apparatus and method embodiments.

### BRIEF DESCRIPTION OF THE DRAWINGS

Referring to the drawings:

FIG. 1 is a schematic diagram of a networked computer environment incorporating an architecture facilitating data transfer between disparate programs, in accordance with the principle of the invention; and

FIG. 2 is a flow chart illustrating data transfer methodology, in accordance with the principle of the invention.

### DETAILED DESCRIPTION OF PREFERRED EMBODIMENTS

Project managers and schedulers in the engineering, construction, architecture, utilities and telecommunications industries require control over project management and scheduling operations, and project management and scheduling software is presently the preferred and most efficient tool for accomplishing complicated planning and scheduling needs. Of the various planning and scheduling software available, exemplary is a type found under the trademark PRIMAVERA. This computer-implemented software application is capable of controlling large and complex projects efficiently, and is designed to handle large-scale, highly sophisticated and multifaceted projects, providing virtually limitless resources and target plans and many ways of organizing, filtering and sorting activities, projects and resources, whether in single or multiuser computer environments. Multiuser implementation is especially important for many business models, both in local networks and global networks, such as the Internet.

Efficient plant management is considerably important for many industries and for manufacturers that utilize large production runs, in which inventory management, stock management, and stock and inventory delivery management are necessary and often indispensable aspects for success. In an effort to accommodate complicated and vast plant management needs, skilled artisans have developed robust and highly organized plant management software, of which the most well known is found under the trademark SAP. Although SAP plant management software and PRIMAVERA scheduling software represent the state of the art, and although it is very important for business leaders to use such programs symbiotically, the applications are disparate and the data produced by each cannot be used by the other. This is greatly frustrating not only for the SAP and PRIMAVERA plant maintenance and scheduling applications, but also for other state of the art plant maintenance and scheduling applications. And so current computer implemented applications that are capable of prosecuting planning and scheduling operations (i.e., operations planning and scheduling applications) and computer applications that are capable of prosecuting plant maintenance operations (i.e., operations management applications) each yield data that are disparate and only capable of being processed in their own unique environments.

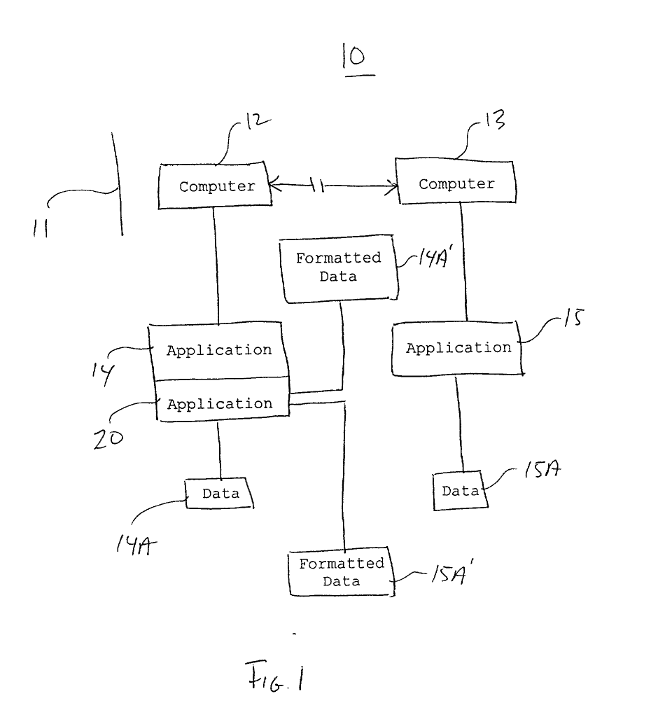

Turning now to the drawings, in which like reference characters indicate corresponding elements throughout the several views, attention is directed to FIG. 1 in which is seen a system, embodying the principle of the invention, generally indicated by the reference character 10 including a network 11 of computers 12,13 and disparate applications 14,15, namely, disparate sets of computer instructions or programs. Consistent with the ensuing discussion, application 14 is a plant management application and application 15 is a planning and scheduling application. This can be reversed. Computers 12,13 communicate with one another via communication lines, such as communication line 16, which characterizes network 11. Although two computers constitute network 11 in FIG. 1, more can be employed. Network 11 can be a local network or a general network, such as a global computer network.

Computer 12 maintains application 14, which is code, namely, a program or application for which computer 12 is used. Computer 13 maintains application 15, which is also code, namely, a program or application for which a computer is used. Applications 14,15 are disparate and yield disparate data. Computers 12,13 are conventional and incorporate typical and expected components including input and output devices, processing apparatus, and storage for maintaining an operating system and software including applications 14,15, further details of which will readily occur to the skilled artisan and will not be discussed.

Computer 12 implements application 14, and computer 13 implements application 15. Computer 12 generates and outputs data 14A in response to implementation of application 14, and computer 13 generates and outputs data 15A in response to implementation of application 15. Because applications 14,15 are disparate, computer 12 is incapable of processing data 15A by implementing application 14, and computer 13 is incapable of processing data 14A by implementing application 15. In accordance with the invention, system 10 incorporates application 20, which is embedded into and symbiotic with application 14. Application 20 is code, namely, a program or application for which a computer is used, and are a persistent symbiotic element of application 14 and initiated in response to data 14A,15A transfer requests by and between computers 12,13. Application 20 is prosecuted by computer 12 and permits computer 12 to receive data 15A from computer 13 and format data 15A into formatted data 15A′, and permits computer 12 to format data 14A into formatted data 14A′ and submit it to computer 13. Formatted data 15A′ are capable of being processed by computer 12 in response to implementation of application 14, and formatted data 14A′ are capable of being processed by computer 13 in response to implementation of application 15.

The invention facilitates data transfer between disparate programs without expensive and complicated middleware. Although the described embodiment is implemented in a networked or multiuser computer environment, it can be implemented by a single computer if desired, in which applications 14,15,20 are implemented by a single computer and data are transferred between applications 14,15 with the implementation of application 20.

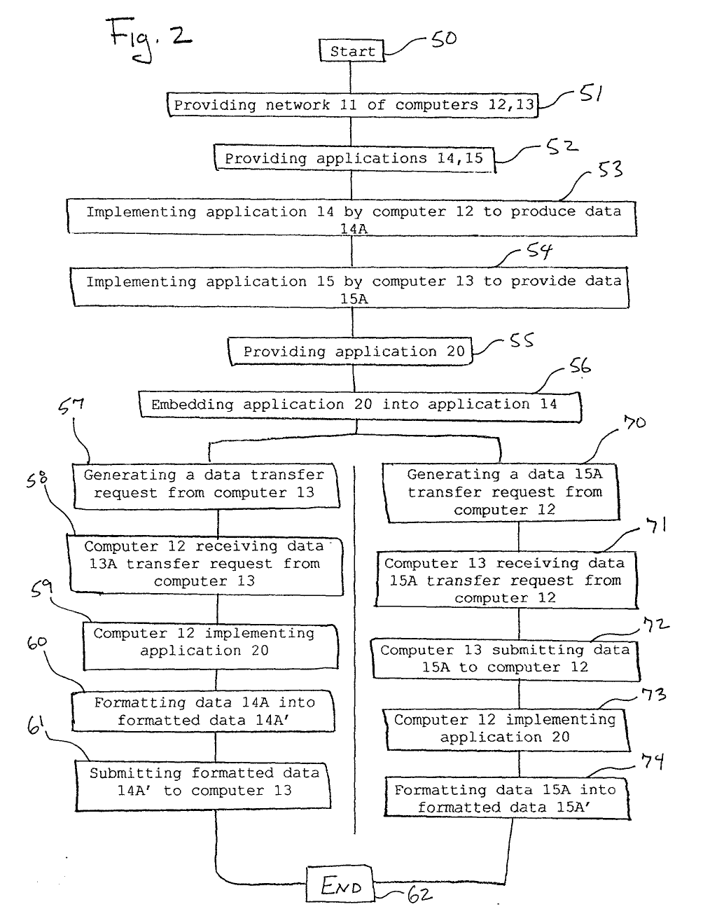

In accordance with the principle of the invention, the invention also contemplates associated methods of transferring disparate data between disparate applications. Turning to FIG. 2, a preferred method of the invention starts 50 by providing 51 network 11 of computers 12,13, providing 52 applications 14,15, implementing 53 application 14 by computer 12 to produce data 14A and implementing 54 application 15 by computer 13 to produce data 15A. Computer 12 is incapable of processing data 15A by implementing application 14, and computer 13 is incapable of processing data 14A by implementing application 15. At this point, the method further includes providing 55 application 20 and embedding 56 application 20 into application 14 so as to become a persistent element of and symbiotic with application 14. Application 20 is responsive to data 14A,15A transfer requests so as to be implemented by computer 12, and permits computer 12 to receive data 15A from computer 13 and format data 15A into formatted data 15A′, and format data 14A into formatted data 14A′ and submit formatted data 14A′ to computer 13. In accordance with the invention, formatted data 15A′ are capable of being processed by computer 12 in response to implementation of application 14, and formatted data 14A′ are capable of being processed by computer 13 in response to implementation of application 15.

In this regard, and in accordance with the invention, the method of the invention further includes generating 57 a data 14A transfer request from computer 13 and computer 12 receiving 58 data 14A transfer request from computer 13. In response to receiving data 14A transfer request from computer 13, computer 12 is responsive implementing 59 application 20 formatting 60 data 14A into formatted data 14A′ and submitting 61 formatted data 14A′ to computer 13 for processing thereby in response to implementation of application 15, which ends 62 the method.

In another embodiment, the method of the invention constitutes generating 70 a data 15A transfer request from computer 12 and computer 13 receiving 71 data 15A transfer request from computer 12. In response to receiving data 15A transfer request from computer 12, computer 13 is responsive submitting 72 the requested data 15A to computer 12. In response to receiving the requested data ISA, computer 12 is responsive implementing 73 application 20 formatting 74 data 15A into formatted data 15A′, which is capable of being processed by computer 12 in response to implementation of application 14, which ends 75 the method.

It will be readily appreciated that application 20 interacts with applications 14,15 and enables data 14A,15A to integrate quickly and easily by and between applications 14,15. In other words, application 20 permit data transfer between applications 14,15 without the assistance of expensive middleware and training. Application 20 is a persistent element of application 14 and runs entirely within application 14, selecting, formatting and mapping data 14A,15A in response to data transfer commands between computers 12,13 and, more particularly, between applications 14,15. Application 20 is easily introduced into the structure of application 14, and functions symbiotically with the structure of application 14 without compromising the functionality of application 14.

The present invention is described above with reference to preferred embodiments. However, those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Apparatus comprising:
disparate first and second applications;
the first application implemented by a computer;
the second application implemented by the computer;
first data output by the computer in response to implementation of the first application by the computer;
second data output by the computer in response to implementation of the second application by the computer;
the computer incapable of processing the second data by implementing the first application;
the computer incapable of processing the first data by implementing the second application;
a third application embedded into the first application;
the third application permitting the computer to format the first data into formatted first data;
the third application permitting the computer to format the second data into formatted second data;
the formatted second data capable of being processed by the computer in response to implementation of the first application; and
the formatted first data capable of being processed by the computer in response to implementation of the second application.

2. Apparatus of claim 1, wherein the first application comprises a plant management application.

3. Apparatus of claim 1, wherein the second application comprises a planning and scheduling application.

4. In a) disparate first and second applications, b) the first application implemented by a computer, c) the second application implemented by the computer, d) first data output by the computer in response to implementation of the first application by the computer, e) second data output by the computer in response to implementation of the second application by the computer, f) the computer incapable of processing the second data by implementing the first application, g) the computer incapable of processing the first data by implementing the second application, apparatus comprising:
a third application embedded into the first application;
the third application permitting the computer to format the first data into formatted first data;
the third application permitting the computer to format the second data into formatted second data;
the formatted second data capable of being processed by the computer in response to implementation of the first application; and
the formatted first data capable of being processed by the computer in response to implementation of the second application.

5. Apparatus of claim 4, wherein the first application comprises a plant management application.

6. Apparatus of claim 4, wherein the second application comprises a planning and scheduling application.

7. Apparatus comprising:
a network of computers;
disparate first and second applications;
the first application implemented by a first one of the computers;
the second application implemented by a second one of the computers;
first data output by the first one of the computers in response to implementation of the first application by the first one of the computers;
second data output by the second one of the computers in response to implementation of the second application by the second one of the computers;
the first one of the computers incapable of processing the second data by implementing the first application;
the second one of the computers incapable of processing the first data by implementing the second application;
a third application of the first application;
the third application permitting the first one of the computers to receive the second data from the second one of the computers and format the second data into formatted second data;
the third application permitting the first one of the computers to format the first data into formatted first data and submit the formatted first data to the second one of the computers;
the formatted second data capable of being processed by the first one of the computers in response to implementation of the first application; and
the formatted first data capable of being processed by the second one of the computers in response to implementation of the second application.

8. Apparatus of claim 7, wherein the network of computers comprises a global network of computers.

9. Apparatus of claim 7, wherein the network of computers comprises a local network of computers.

10. Apparatus of claim 7, wherein the first application comprises a plant management application.

11. Apparatus of claim 7, wherein the second application comprises a planning and scheduling application.

12. In a) a network of computers, b) disparate first and second applications, c) the first application implemented by a first one of the computers, d) the second application implemented by a second one of the computers, e) first data output by the first one of the computers in response to implementation of the first application by the first one of the computers, f) second data output by the second one of the computers in response to implementation of the second application by the second one of the computers, g) the first one of the computers incapable of processing the second data by implementing the first application, and h) the second one of the computers incapable of processing the first data by implementing the second application, apparatus comprising:
a third application of the first application;
the third application permitting the first one of the computers to receive the second data from the second one of the computers and format the second data into formatted second data;
the third application permitting the first one of the computers to format the first data into formatted first data and submit the formatted first data to the second one of the computers;
the formatted second data capable of being processed by the first one of the computers in response to implementation of the first application; and
the formatted first data capable of being process by the second one of the computers in response to implementation of the second application.

13. Apparatus of claim 12, wherein the first application comprises a plant management application.

14. Apparatus of claim 12, wherein the second application comprises a planning and scheduling application.

15. A method comprising steps of:
providing a network of computers;
providing disparate first and second applications;
implementing the first application by a first one of the computers to produce first data;
implementing the second application by a second one of the computers to produce second data;
the first one of the computers incapable of processing the second data by implementing the first application;
the second one of the computers incapable of processing the first data by implementing the second application;
providing a third application;
embedding the third application into one the first application;
the third application permitting the first one of the computers to receive the second data from the second one of the computers and format the second data into formatted second data;
the third application permitting the first one of the computers to format the first data into formatted first data and submit the formatted first data to the second one of the computers;
the formatted second data capable of being processed by the first one of the computers in response to implementation of the first application; and
the formatted first data capable of being processed by the second one of the computers in response to implementation of the second application.

16. In a) a network of computers, b) disparate first and second applications, c) the first application implemented by a first one of the computers, d) the second application implemented by a second one of the computers, e) first data output by the first one of the computers in response to implementation of the first application by the first one of the computers, f) second data output by the second one of the computers in response to implementation of the second application by the second one of the computers, g) the first one of the computers incapable of processing the second data by implementing the first application, and h)the second one of the computers incapable of processing the first data by implementing the second application, a method comprising steps of:
providing a third application;
embedding the third application into one the first application;
the third application permitting the first one of the computers to receive the second data from the second one of the computers and format the second data into formatted second data;
the third application permitting the first one of the computers to format the first data into formatted first data and submit the formatted first data to the second one of the computers;
the formatted second data capable of being processed by the first one of the computers in response to implementation of the first application; and
the formatted first data capable of being processed by the second one of the computers in response to implementation of the second application.
